(19) United States
(12) Patent Application Publication
(10) Pub. No.: US 2005/0237205 A1
(43) Pub. Date: Oct. 27, 2005

(54) Security tag device

(75) Inventor: Alan Jeffrey Gorst, Saddleworth (GB)

Correspondence Address: John S. Egbert;Harrison & Egbert, 7th Floor, 412 Main Street, Houston, TX, 77002, US

(73) Assignee: SPORTS-TAG Limited, Warrington (GB)

(21) Appl. No.: 11/100,737

(22) Filed: Apr. 7, 2005

(30) Foreign Application Priority Data
Apr. 7, 2004 (GB) 0408022.2

(51) Int. Cl. G08B 13/14

(52) U.S. Cl. 340/572.9

(57) ABSTRACT

A security tag device is provided such as may be used to tag an article such as a baseball bat or a bottle that has a neck adjoining a flanged head. The device is intended to provide a protection against theft where such articles are on display for handling by prospective purchasers. To this end the device comprises first and second portions. The first portion is adapted to fit over the head and partially around the neck adjoining the flange defined between the head and the neck of the article. The second portion is co-operable with the first portion and adapted to fit around the rest of the neck adjoining the flange such that together the first and second portions can encircle the neck of the article. At least one detent is provided which is connected to one of the portions and which can engage a part of the other portion to lock the two portions together. A tell-tale security provision is enclosed within a receptacle defined by at least one of the first and the second portions. In use, the first and second portions are rotatable relative to each other in order that in an unlocked state the device can be fitted over the head of the article and then the first and second portions rotated relatively into a locked state wherein they together encircle the neck and wherein the detent is deployed to lock them together so that they are no longer relatively rotatable, thus preventing removal of the device from the article.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a security tag device such as may be used to tag articles to provide a protection against theft where such articles are on display for handling by prospective purchasers.

### BACKGROUND OF THE INVENTION

The invention has arisen from the particular considerations of anti-theft security for articles such as baseball bats, bottles and other articles with a flanged or enlarged head. Articles of this type usually have a large body, a neck and a flanged head. It is usually not appropriate to attach a security device to the main body portion of the article so that conventional security tags are attached to the neck or to the head. However, the security tags currently in use tend either to comprise a strap that fits around the neck of the article or to comprise a hinged body that can be fitted around neck. Both of these types of device have disadvantages. The devices incorporating straps are readily removable by thieves that can slit the strap. Hinged devices are usually vulnerable to attack at the hinge. In addition, both types of device can be difficult to apply and remove.

### BRIEF SUMMARY OF THE INVENTION

The object of the present invention is to provide a security device for use with articles with a flanged head which overcomes or substantially mitigates the aforesaid disadvantages of conventional devices.

According to the present invention there is provided a security tag device for an article with a neck adjoining a flanged head comprising a first portion adapted to fit over the head and partially around the neck adjoining the flange defined between the head and the neck of the article; a second portion co-operable with the first portion and adapted to fit around the rest of the neck adjoining the flange such that together the first and second portions can encircle the neck of the article; at least one detent which is connected to one of the portions and which can engage a part of the other portion to lock the two portions together; and a tell-tale security provision enclosed within a receptacle defined by one of the first and the second portions; the first and second portions being rotatable relative to each other from an unlocked state, wherein the device can be fitted over the head of the article, into a locked state, wherein the first and second portions together encircle the neck and wherein the detent is deployed to lock the first and second portions together so that they are no longer relatively rotatable.

It will be appreciated that the security device is adapted to be made of a size comparable to the size of the flanged head and neck of the article to be protected in order that when the device is locked around the neck of the article, the flange between the head and the neck prevents the device from being removed until it is unlocked.

Preferably, the detent deploys automatically to lock the first and second portions together when the first and second portions are rotated into a position wherein the detent is able to engage said part of the second portion

Preferably also, two detents are provided on opposite sides of the device.

Preferably also, each detent comprises a spring-loaded catch rotatably mounted to the first portion which can engage a stop defined by the second portion.

In one embodiment, the detents comprise a ferromagnetic material such that they can be moved against the force of the spring-loading by a magnet.

Alternatively, each detent resiliently engages said part of the second portion in a snap-fit manner. In this case, preferably both portions comprise integral projections that resiliently inter-engage with one another when the first and second portions are rotated into the locked position.

Preferably also, the first and second portions can only be released from their locked state by means of a tool, a key or a magnetic device separate from the security tag device.

Preferably also, the device is adapted to fit over and around the head of the article such that when the first and second portions are locked together encircling the neck of the article, the head of the article is enclosed.

Preferably also, the first and second portions comprise part-annular sleeves that embrace the head and encircle the neck of the article when the portions are locked together.

Preferably also, the part-annular sleeve defined by the first portion has a smaller diameter than the part-annular sleeve defined by the second portion in order that when the first and second portions rotate relative to one another the first portion can rotate within the part-annular sleeve defined by the second portion.

Preferably also, the first and second portions engage one another by means of a projection provided on one of the portions that slides in a groove defined in the other portion when the two portions rotate relative to one another.

Preferably also, the second portion comprise two inter-engaging elements that together define the part-annular sleeve.

Preferably also, the first and second elements engage by means of a first tongue and groove arrangement.

Preferably also, the second element engages the first portion of the device by means of a second tongue and groove arrangement.

Preferably also, the first portion defines the receptacle in which the tell-tale security provision is located, in which receptacle is also located the detent or detents.

Preferably also, the receptacle is closed by a cover that is snap-fitted to at least one of the first and second portions.

Preferably also, the cover defines at least one aperture through which a tool or key can be inserted to unlock the detent after the first and second portions have been rotated relative to each other into their locked state.

The present invention will now be described by way of example with reference to the accompanying drawings.

### BRIEF DESCRIPTION OF THE SEVERAL VIEWS OF THE DRAWINGS

FIGS. 1 and 2 are perspective views respectively of a baseball bat and a bottle each fitted with a security device in accordance with the invention;

FIG. 3 is side view of the device shown in FIG. 1 when in a locked position;

FIG. 4 is a plan view of the device shown in FIG. 3 but with a cover removed;

FIG. 5 is a view from below of the device shown in FIG. 4;

FIG. 6 is a sectional view along the line A-A in FIG. 5 showing the device when in a locked state;

FIG. 7 is a sectional view along the line A-A in FIG. 4 showing the device when in an unlocked state;

FIG. 8 is an exploded perspective view from above and one side of the device shown in FIG. 1;

FIG. 9 is a view similar to FIG. 8 but from below and the other side;

FIG. 10 is a perspective view of a longitudinal section, to an enlarged scale, of a device similar to that of FIG. 1 but incorporating a modified locking arrangement;

FIG. 11 is a view similar to FIG. 10 but showing the device in an unlocked state and with a magnetic unlocking tool applied thereto.

### DETAILED DESCRIPTION OF THE INVENTION

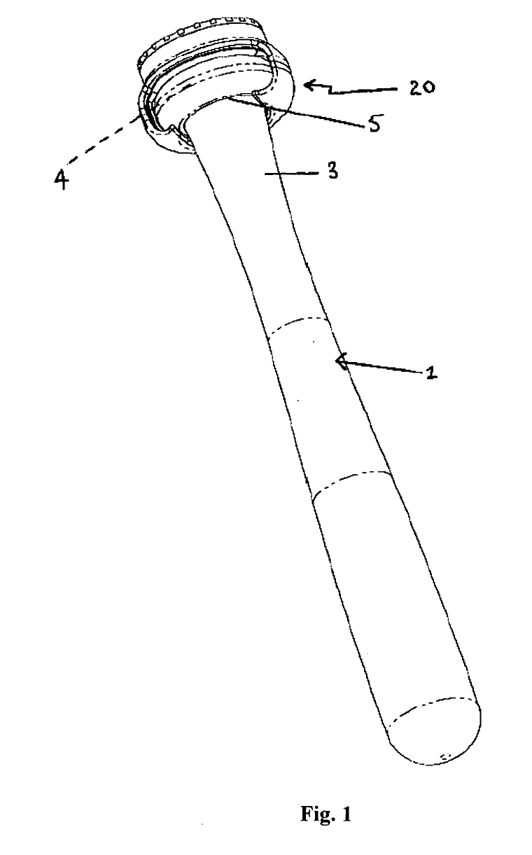

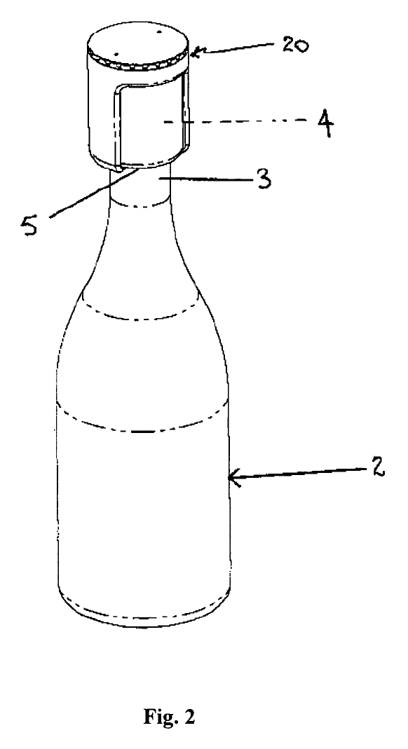

As shown in FIGS. 1 and 2, a security device 20 according to the invention is designed for fitment to an article such as a baseball bat 1 or a bottle 2, both of which comprise a neck 3 adjoining a flanged head 4, the flange 5 being defined by the head 4 where it joins the neck 3.

It will be appreciated from FIGS. 1 and 2 that the security device 20 of the invention is intended to be shaped such that it conforms closely to the shape of the head 4 of the article it is intended to protect. However, in both cases the construction and method of operation of the device 20 is the same. Construction of similar devices 20 for the protection of other articles with a neck adjoining a flanged head is equally possible.

This description will now proceed using an example of a device 20 as shown in FIG. 1 for attachment to a baseball bat.

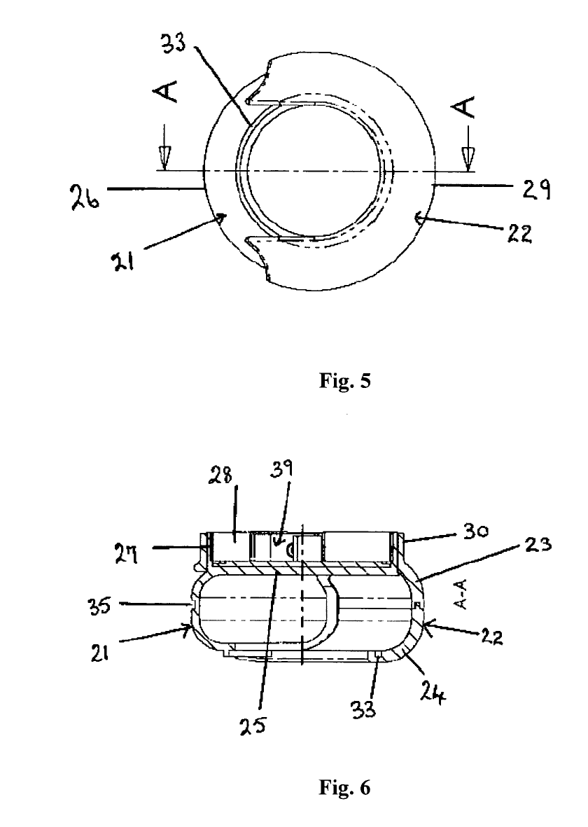

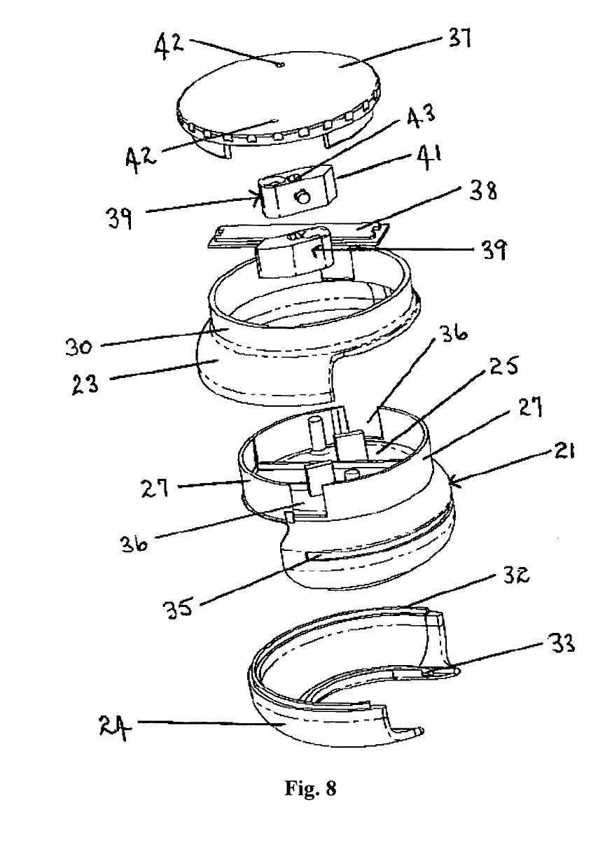

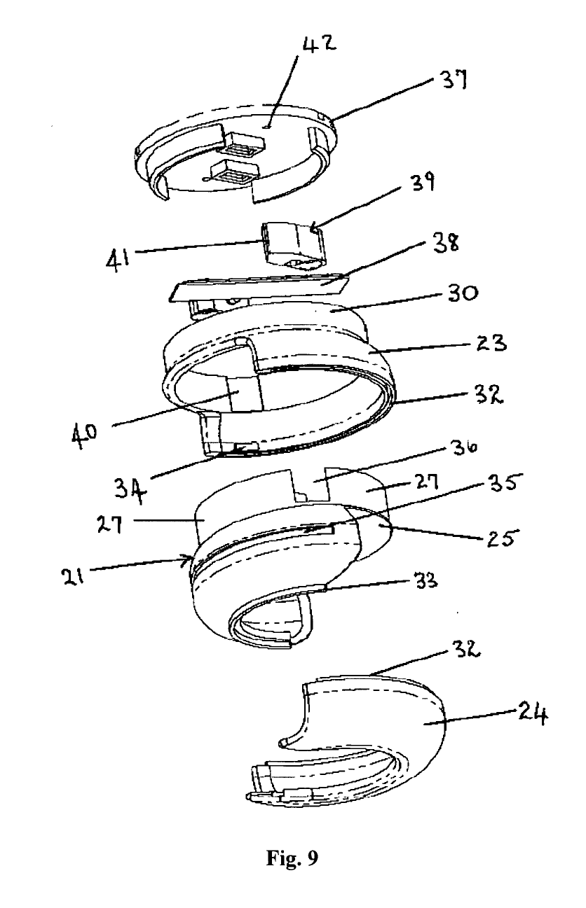

The security device 20 as shown in FIGS. 1 and 3 to 9 comprises first and second co-operating portions 21 and 22. Preferably, these portions 21 and 22 comprise plastics mouldings but any suitable material can be used. The portion 21 can be integrally moulded but, for ease of construction, the second portion 22 is preferably made from two separate, inter-engaging elements 23, 24 (see FIGS. 8 and 9), as is described below, that are secured together during assembly of the device 20.

The first portion 21 is adapted to fit over the head 4 and partially around the neck 3 adjoining the flange 5 of an article such as a baseball bat 1 and comprises a plate 25 that is intended to lie over the top of the head 4 of the article, a part-annular sleeve 26, and two upstanding part circular walls 27 adjoining the cover 25 such that the plate 25 and the walls 27 define a receptacle 28.

As indicated above, the shape of the part-annular sleeve 26 follows closely the exterior profile of the head 4 of the article to which the device 20 is to be fitted. However, in all cases, the sleeve 26 is adapted to fit around part of the head 4 and engage beneath the flange 5 defined between the head 4 and the neck 3 of the article.

The second portion 22 of the device is adapted to fit around the rest of the head 4 and neck 3 adjoining the flange 5 such that together the first and second portions 21 and 22 can embrace the head 4 and encircle the neck 3 of the article, as shown in FIG. 1. As with the first portion 21, the second portion 22 also comprises a part-annular sleeve 29 that is defined by the two elements 23 and 24 when they are fitted together. One of the elements 23 comprises a cylindrical wall 30 that fits around the walls 27 of the first portion 21. In addition the element 23 comprises an upper portion 31 of the part-annular sleeve 29 that is shaped so that it conforms closely to the exterior profile of the upper part of the head 5 of the article. The other element 24 defines the rest of the part-annular sleeve 29 and engages with the first element 23 by means of a tongue and groove arrangement 32. Adhesive may also be employed to secure the two elements 23 and 24 together permanently during assembly of the device 1.

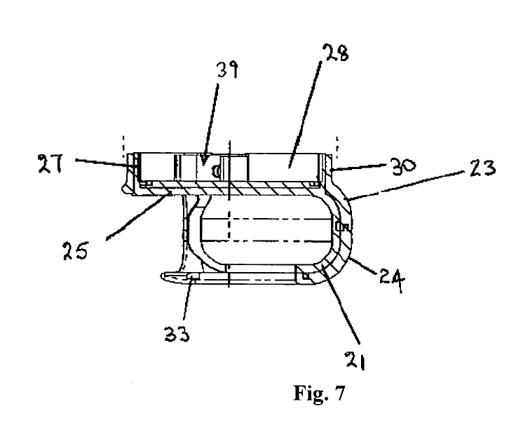

The portions 21 and 22 are capable of being rotated relative to each other from a first position, as shown in FIG. 7, wherein the device 20 can be fitted over the head 4 of the article 1, into a second position wherein the first and second portions 21 and 22 encircle the neck 3, as shown in FIG. 6 and the other drawings apart from FIG. 7. To this end, the part-annular sleeve 26 defined by the first portion 21 has a smaller diameter than the part-annular sleeve 29 defined by the second portion 22 in order that the first and second portions 21 and 22 can rotate relative to one another with part-annular sleeve 26 rotating within the part-annular sleeve 29. In this way, the portions 21 and 22 can enclose the head 4, encircling the neck 3 of the article. In this second position, the two portions 21 and 22 are designed to be locked together so that they are no longer relatively rotatable. As a result, the device 20 cannot be pulled off or otherwise removed from the article 1 after fitment unless the portions 21 and 22 are unlocked and rotated back into their first position.

In order to aid the relative rotation of the portions 21 and 22 and prevent them from slipping out of position relative to one another, the element 24 of the second portion 22 engages the first portion 20 by means of a second tongue and groove arrangement 33 located in the portions of the part-annular sleeves 27 and 29 intended to sit adjacent the flange 5 of the article. Also, the element 23 engages the first portion 21 by means of a projection 34 provided on the interior surface of the element 23 that slides in a groove 35 defined in the outer surface of the portion 21. Optionally, this positioning of the projection 34 and the groove 35 could be reversed.

It will be appreciated that the receptacle 28 is effectively closed by the outer wall 30 of the second portion 22, which closes the two gaps 36 left between the walls 27, and by a cover 37 that can be snap-fitted or otherwise securely fixed to the inner walls 27 or other part of the first portion 21 in a tamper-proof manner. The reason for this is that a tell-tale security provision 38 is located within the receptacle 28. The provision 38 can be of any suitable conventional type, such as a magnetic or RF device.

The locking arrangement provided for the device 20 comprises at least one detent 39 which is connected to one of the portions 21 and 22 and which can engage a stop 40 defined by the other portion to lock the two portions together.

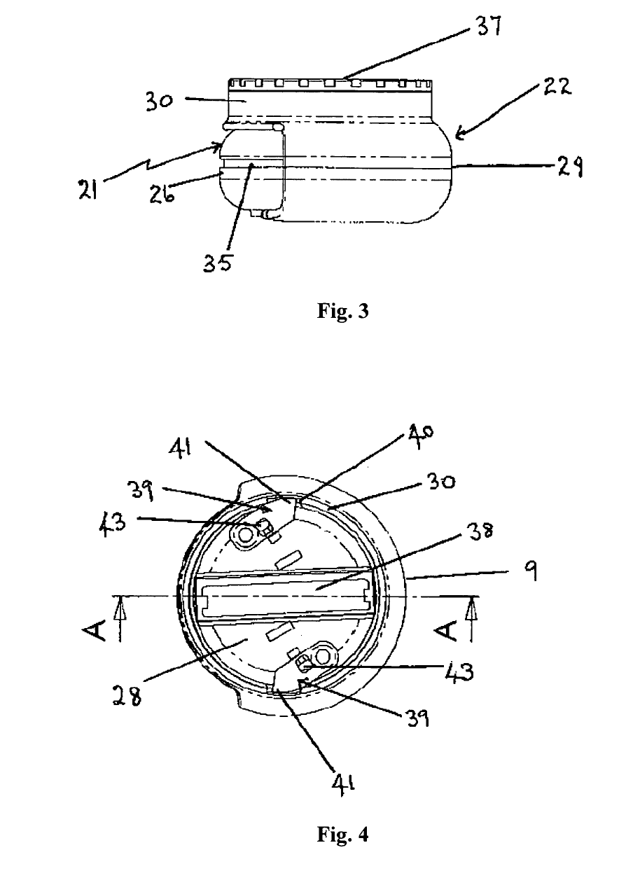

In a first embodiment, as shown in FIGS. 3 to 9, two spring-loaded detents 39 are provided within and on opposite sides of the receptacle 28. The detents 39 are shaped with noses 41 that are urged outwards relative to the longitudinal axis of the device 1 by the spring loading through the gaps 36 defined by the walls 27 into close contact with the interior surface of the wall 30 of the second portion 22. However, this wall 30 is provided on opposite sides thereof with two stops 40 in the form of sockets. When the portions 21 and 22 are rotated relative to one another such that the wall 30 rotates relative to the walls 27 it will be appreciated that at a certain position the sockets 40 align with the gaps 36 between the walls 27. When this happens, the noses 41 are urged into the sockets 40 by the spring loading and owing to their shape jam against one of the edges of each of sockets 40 such that any further relative rotation of the portions 21 and 22 is thereby prevented. The portions 21 and 22 are thereby locked together so that they are no longer relatively rotatable in either direction.

The device is designed so that the sockets 40 are located in the wall 30 in positions wherein the noses 41 enter them when the part-annular sleeve 31 of the second portion 22 covers the open portion of the part-annular sleeve 29 of the second portion 22. That is, when the portions 21 and 21 have rotated relatively through 180° from the position shown in FIG. 7 wherein the device 20 can be located over the head 4 of the article to be protected.

In this locked state, the device 20 can only be disengaged from the article by using a specially designed tool or key to prevent readily available tools such as screwdrivers and the like being used illegally to remove the device 20 from the article. To this end, the cover 25 is provided with two small apertures 42 that align respectively with a slot 43 formed in one of the detents 39. By locating a pair of prongs of a pronged tool through the apertures 42 to engage in the slots 43, the detents 39 can be moved against the force of their springs so that they disengage from the sockets 40, unlocking the device 20. The two portions 20 and 21 can then again be relatively rotated and the device 20 removed from the head 4 of the article.

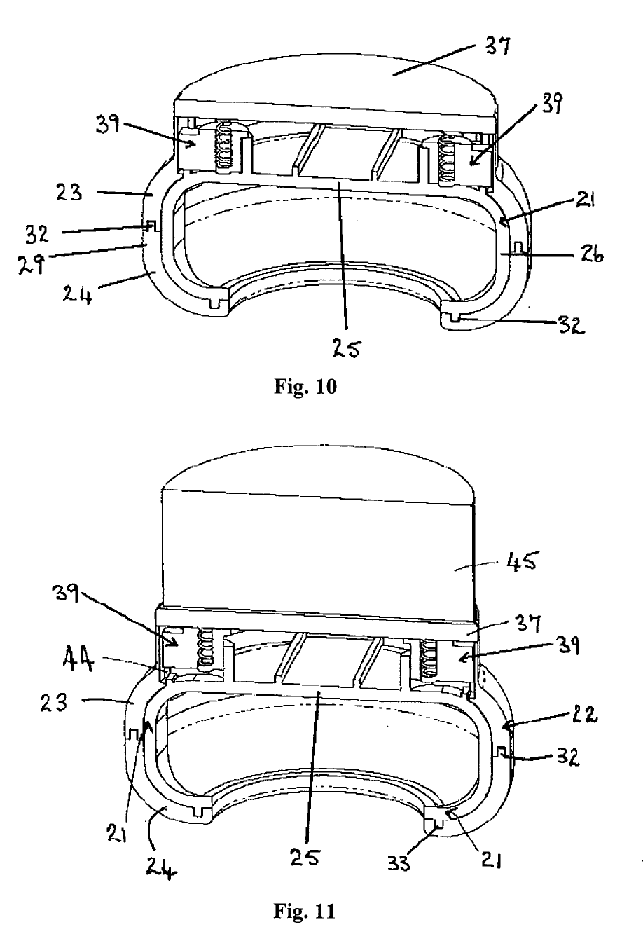

Other forms of detent can be provided to lock the two portions 21 and 22 against relative rotation. In a modification, as shown in FIGS. 10 and 11, the detents 39 comprise a ferromagnetic material and rather than being urged outwardly into sockets 40 are urged towards the plate 25, which is provided with stops 44 that can contact the detents 39 to prevent further relative rotation of the portions 21 and 22. In this case the tool 45 used to unlock the device 20 comprises a magnetic key which when appropriately located over the cover 37 lifts the detents 39 against the loading of springs 45 so that they can clear the stops 44.

In other embodiments of the device (not shown) the detent or detents can be arranged to resiliently engage a part of the second portion 22 in a snap-fit manner. For example, both portions 21, 22 can be provided with integral projections that resiliently inter-engage with one another when the first and second portions are rotated into the locked position.

In all cases, however, it is preferably for the detent 39 to deploy automatically to lock the first and second portions 21 and 22 together so that a positive locking action on the part of the shop-worker or similar is not required. This is advantageous as it saves time when the devices 20 are being fitted to the articles and reduces the number of unlocking tools or keys required.

1. A security tag device for an article with a neck adjoining a flanged head, said security tag device comprising:
a first portion adapted to fit over the head and partially around the neck adjoining the flange defined between the head and the neck of the article;
a second portion co-operable with the first portion and adapted to fit around the rest of the neck adjoining the flange, together the first and second portions encircling the neck of the article;
at least one detent connected to one of the portions and engaged to a part of the other portion, locking the two portions together; and
a tell-tale security provision enclosed within a receptacle defined by at least one of the first and the second portions; the first and second portions being rotatable relative to each other from an unlocked state,
wherein the device can be fitted over the head of the article, into a locked state, and wherein the first and second portions together encircle the neck and wherein the detent is deployed to lock the first and second portions together so that they are no longer relatively rotatable.

2. A device as claimed in claim 2, wherein the detent deploys automatically to lock the first and second portions together when the first and second portions are rotated into a position wherein the detent is able to engage said part of the second portion.

3. A device as claimed in claim 1, wherein two detents are provided on opposite sides of the device.

4. A device as claimed in claim 1, wherein each detent comprises a spring-loaded catch rotatably mounted to the first portion which can engage a stop defined by the second portion.

5. A device as claimed in claim 4, wherein each detent is comprised of a ferromagnetic material such that they can be moved against the force of the spring-loading by a magnet.

6. A device as claimed in claim 1, wherein each detent resiliently engages said part of the second portion in a snap-fit manner.

7. A device as claimed in claim 6, wherein the first and second portions both comprise integral projections that resiliently inter-engage with one another when the first and second portions are rotated into the locked position.

8. A device as claimed in claim 1, wherein the first and second portions can only be released from their locked state by means of a tool, a key or a magnetic device separate from the security tag device.

9. A device as claimed in claim 1, being adapted to fit over and around the head of the article such that when the first and second portions are locked together encircling the neck of the article, the head of the article is enclosed.

10. A device as claimed in claim 1, wherein the first and second portions comprise part-annular sleeves that enclose the head and encircle the neck of the article when the portions are locked together.

11. A device as claimed in claim 10, wherein the part-annular sleeve defined by the first portion has a smaller diameter than the part-annular sleeve defined by the second portion in order that when the first and second portions rotate relative to one another the first portion can rotate within the part-annular sleeve defined by the second portion.

12. A device as claimed in claim 10, wherein the second portion comprises two inter-engaging elements that together define the part-annular sleeve.

13. A device as claimed in claim 12, wherein the two elements engage by a first tongue and groove arrangement.

14. A device as claimed in claim 12, wherein one of the elements engages the first portion of the device by a second tongue and groove arrangement.

15. A device as claimed in claim 1, wherein the first and second portions engage one another by a projection provided on one of the portions that slides in a groove defined in the other portion when the two portions rotate relative to one another.

16. A device as claimed in claim 1, wherein the detent or detents are also located within the receptacle in which the tell-tale security provision is located.

17. A device as claimed in claim 1, wherein the receptacle is closed by a cover that is snap-fitted to at least one of the first and second portions.

18. A device as claimed in claim 17, wherein the cover defines at least one aperture through which a tool or key can be inserted to unlock the detent after the first and second portions have been rotated relative to each other into their locked state.
